(19) United States
(12) Patent Application Publication
(10) Pub. No.: US 2026/0172759 A1
(43) Pub. Date: Jun. 18, 2026

(54) COMPRESSION SCHEME IMPLEMENTED BY A HEARING DEVICE

(71) Applicant: Starkey Laboratories, Inc., Eden Prairie, MN (US)

(72) Inventors: Kenneth Kragh Jensen, Shakopee, MN (US); Henning Schepker, Oldenburg (DE); Martin F. McKinney, Minneapolis, MN (US); Benjamin Waite, St. Louis Park, MN (US)

(21) Appl. No.: 19/419,796

(22) Filed: Dec. 15, 2025

Related U.S. Application Data
(60) Provisional application No. 63/734,290, filed on Dec. 16, 2024.

(51) Int. Cl. H04R 25/00; G10L 21/0232; G10L 21/0264; G10L 21/0364

(52) U.S. Cl. CPC H04R 25/356; G10L 21/0232; G10L 21/0264; G10L 21/0364; H04R 2225/43; H04R 2430/03

(57) ABSTRACT

A hearing device comprises at least one microphone, a receiver or speaker, and a controller comprising one or more processors configured to implement a sparsity compression scheme. The controller, when implementing the sparsity compression scheme, is configured to apply a fast and high degree of compression to an input signal received by the microphone to provide a compressed signal, filter the input signal by which intense portions of the input signal above a threshold are assigned a high gain value and less intense portions of the input signal below the threshold are assigned a low gain value, the high and low gain values defining sparsity gains, and apply the sparsity gains to the compressed signal to produce an output signal communicated to the receiver or speaker.

This application claims the benefit of U.S. Provisional Application No. 63/734,290, filed Dec. 16, 2024, the disclosure of which is incorporated by reference herein in its entirety.

### TECHNICAL FIELD

This application relates generally to ear-level electronic systems and devices, including hearing devices, personal amplification devices, hearing aids, hearables, and other ear-wearable electronic devices.

### SUMMARY

Embodiments are directed to a method implemented by a hearing device comprising receiving an input signal comprising speech and applying a fast and high degree of compression to the input signal to provide a compressed signal. The method also comprises filtering the input signal by which intense portions of the input signal above a threshold are assigned a high gain value and less intense portions of the input signal below the threshold are assigned a low gain value, the high and low gain values defining sparsity gains. The method further comprises applying the sparsity gains to the compressed signal to produce an output signal.

Embodiments are directed to a hearing device comprising at least one microphone, a receiver or speaker, and a controller comprising one or more processors configured to implement a sparsity compression scheme. The controller, when implementing the sparsity compression scheme, is configured to apply a fast and high degree of compression to an input signal received by the microphone to provide a compressed signal, filter the input signal by which intense portions of the input signal above a threshold are assigned a high gain value and less intense portions of the input signal below the threshold are assigned a low gain value, the high and low gain values defining sparsity gains, and apply the sparsity gains to the compressed signal to produce an output signal communicated to the receiver or speaker.

The above summary is not intended to describe each disclosed embodiment or every implementation of the present disclosure. The figures and the detailed description below more particularly exemplify illustrative embodiments.

### BRIEF DESCRIPTION OF THE DRAWINGS

The patent or application file contains at least one color photograph executed in color. Copies of this patent or patent application publication with color photograph(s) will be provided by the Office upon request and payment of the necessary fee.

Throughout the specification reference is made to the appended drawings wherein:

FIG. 1 illustrates a representative hearing device configured to implement a sparsity compression scheme in accordance with any of the embodiments disclosed herein;

FIG. 2 is a method illustrating a sparsity compression scheme in accordance with any of the embodiments disclosed herein;

FIG. 3 is a block diagram illustrating a sparsity compression scheme in accordance with any of the embodiments disclosed herein;

FIG. 4 illustrates a process of filtering an input signal comprising speech as part of a sparsity compression scheme in accordance with any of the embodiments disclosed herein;

FIG. 5 is an illustration of intensity filter gains resulting from implementation of a sparsity compression scheme in accordance with any of the embodiments disclosed herein;

FIG. 6 are plots of different compressor processing schemes illustrating the performance of a representative sparsity compression scheme relative to other compression schemes in accordance with any of the embodiments disclosed herein; and

FIG. 7 illustrates a representative hearing device configured to implement a sparsity compression scheme in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Individuals with severe to profound hearing loss only have a limited dynamic range available in which they can hear. In theory, individuals with severe to profound hearing loss fitted with hearing aids require a fast and high degree of compression to fit the speech input range to the limited dynamic range of the patient. This, however, flattens and distorts both spectral and temporal envelope cues which such individuals rely heavily on to understand speech. This leads to unintelligible speech for this group of individuals as the spectral and temporal envelope cues they rely on get washed out.

A traditional solution involves the use of linear gain or slow compression with output limiting to conserve spectro-temporal cues. Such a solution, however, sacrifices audibility in soft to moderately loud environments and/or comfort and sound quality in loud environments. For example, multiband wide dynamic range compression can be used to compress the dynamic range of sounds in the environment into a range which is audible to the hearing device wearer while not getting too loud per frequency band. Usually, due to sound quality concerns, a compression ratio of at most 3:1 has been used. This means that these individuals are currently underfit and are missing out on the softer input levels, given that the fitting is limited by the amount of gain prescribed for loud sounds. It is possible to increase the compression ratio and the speed of compression to overcome this, but sound quality and more importantly speech intelligibility can suffer as a result. This is so because spectral and temporal envelope cues that this population relies more heavily on are washed out.

Embodiments of the disclosure are directed to a compression scheme which combines a fast and high degree of compression with a post-filtering mechanism that passes through only some of the key components of speech, such as formants, which restores key spectro-temporal cues and renders the compressed speech much more intelligible. Embodiments of the disclosure overcome the deficiencies of conventional compression schemes discussed above by applying post-processing of the compressed signal to include only the most prominent components of speech, which simplifies the speech and eliminates some of the speech self-masking arising from the compression.

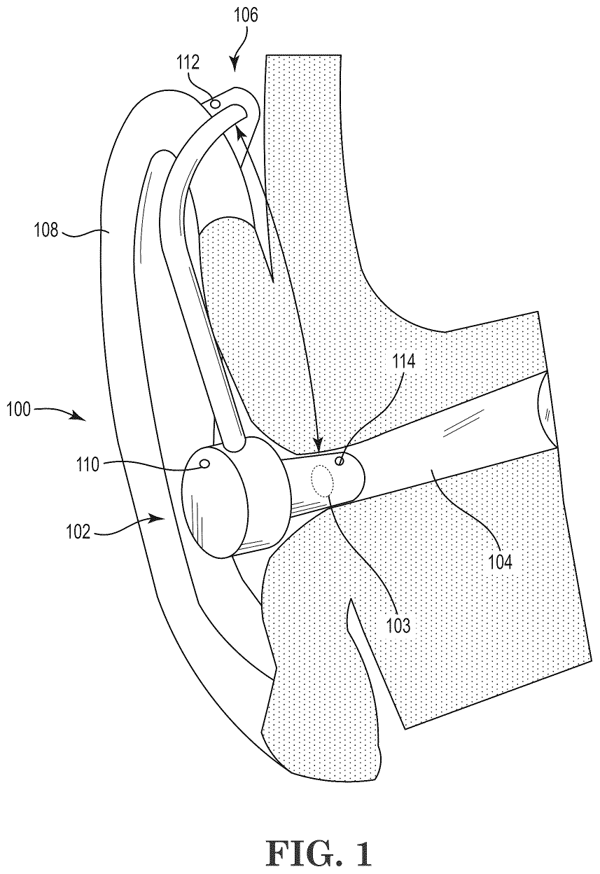

In FIG. 1, a diagram illustrates an example of an ear-wearable hearing device 100 according to an example embodiment. The hearing device 100 includes an in-ear portion 102 that fits into the ear canal 104 of a user/wearer. The hearing device 100 may also include an external portion 106, e.g., worn over the back of the outer ear 108. The external portion 106 is electrically and/or acoustically coupled to the in-ear portion 102. The in-ear portion 102 may include an acoustic transducer 103, although in some embodiments the acoustic transducer may be in the external portion 106, where it is acoustically coupled to the ear canal 104, e.g., via a tube. The acoustic transducer 103 may be referred to herein as a receiver or a speaker.

One or both portions 102, 106 may include an external microphone, as indicated by respective microphones 110, 112. If the device has an external portion 106, it may have two microphones 112 (e.g., front and rear microphones). The hearing device 100 may also include an internal microphone 114 that detects sound inside the ear canal 104. The internal microphone 114 may also be referred to as an inward-facing microphone or error microphone.

Other components of hearing device 100 not shown in the figure may include a processor (e.g., a digital signal processor or DSP), memory circuitry, power management and charging circuitry, one or more communication devices (e.g., one or more radios, a near-field magnetic induction (NFMI) device), one or more antennas, buttons and/or switches, for example. The hearing device 100 can incorporate a long-range communication device, such as a Bluetooth® transceiver or other type of radio frequency (RF) transceiver.

While FIG. 1 shows one example of a hearing device, often referred to as a hearing aid, the term hearing device of the present disclosure may refer to a wide variety of ear-level electronic devices that can aid a person with impaired hearing (e.g., severe to profound hearing loss). Hearing devices include, but are not limited to, behind-the-ear (BTE), in-the-ear (ITE), in-the-canal (ITC), invisible-in-canal (IIC), receiver-in-canal (RIC), receiver-in-the-ear (RITE) or completely-in-the-canal (CIC) type hearing devices or some combination of the above. Throughout this disclosure, reference is made to a “hearing device” or “ear-wearable device,” which is understood to refer to a system comprising a single left ear device, a single right ear device, or a combination of a left ear device and a right ear device.

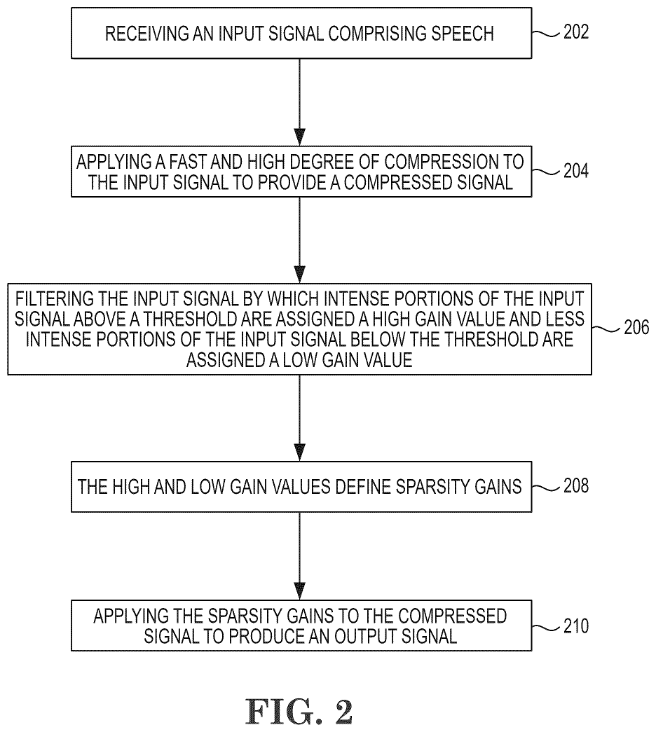

FIG. 2 illustrates a method of processing sound received by a hearing device configured to implement a sparsity compression scheme in accordance with any of the embodiments disclosed herein. The method shown in FIG. 2 involves receiving 202 an input signal comprising speech. The method involves applying 204 a fast and high degree of compression to the input signal to provide a compressed signal. According to some embodiments, the fast compression can comprise attack and release time constants of 100 ms or less (e.g., 50 ms or less). The high degree of compression can comprise a compression ratio of 7:1 or higher (e.g., 10:1 or higher).

The method also involves filtering the input signal by which intense portions of the input signal above a threshold are assigned a high gain value and less intense portions of the input signal below the threshold are assigned a low gain value. The high gain value can be a gain of one, and the low gain value can be a suppressive gain value (e.g., a gain of 0.01). The high and low gain values define sparsity gains 208. The method further involves applying 210 the sparsity gains to the compressed signal to produce an output signal.

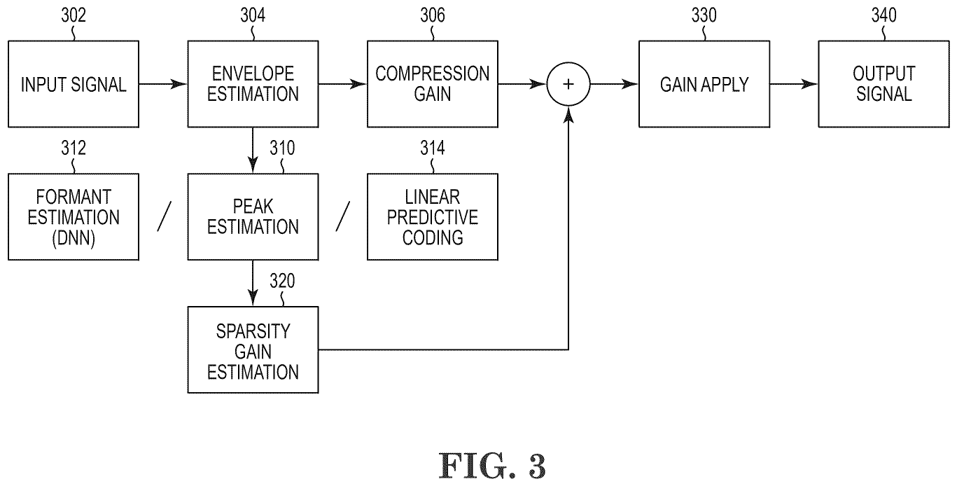

FIG. 3 is a block diagram illustrating a sparsity compression scheme in accordance with any of the embodiments disclosed herein. As shown in FIG. 3, an input signal 302 comprising speech is received by one or more microphones of a hearing device. The envelope of the input signal is estimated 304 using a known technique. The envelope of the input signal is subject to a fast and high degree of compression 306 to provide a compressed signal.

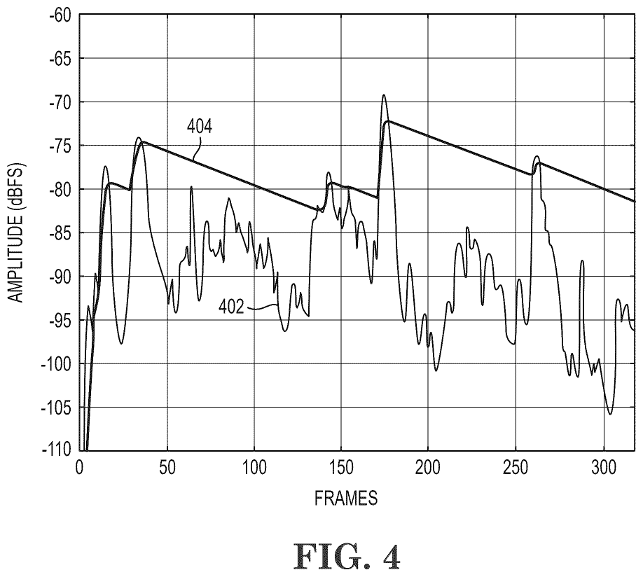

The envelope of the input signal is filtered to produce a sparsity gain estimation 320. Filtering of the input signal can be implemented using a formant estimation technique 312, such as one that uses a deep neural network, a peak estimation technique 310 (see FIG. 4 discussion below), or a linear predictive coding technique 314. The sparsity gains are applied 330 to the compressed signal to produce an output signal 340 which is communicated to a receiver or speaker of the hearing device.

FIG. 4 illustrates a process of filtering an input signal comprising speech as part of a sparsity compression scheme in accordance with any of the embodiments disclosed herein. FIG. 4 shows an example of a peak estimation process discussed previously with reference to FIG. 3. FIG. 4 shows the envelope of an input signal 402 of a single frequency band and a maximum tracking signal 404. The input signal 402 comprises speech. The filtering process shown in FIG. 4 filters the input signal 402 such that only the dominant (intense) portions of the input signal 402, such as the formants, are passed through. The filtering process is performed on a per frequency band basis. The filtering process simplifies speech and restores some of the key spectral and envelope cues resulting in a much more intelligible speech signal and improves sound quality.

The filtering process shown in FIG. 4 involves detecting the peaks of the input signal 402 and tracking these peaks per frequency band. Intensity filtering is applied to the input signal 402 such that a high gain (e.g., a gain of one) is assigned for any portion of the input signal 402 that is within a set amount of dB (e.g., 10 dB) of the maximum tracking signal 404. Any portion of the input signal 402 below this threshold is assigned a low gain (e.g., 0.01), referred to as the suppressive gain. The intensity filter gains, referred to as sparsity gains, are then applied to a highly compressed input signal resulting in a signal with higher contrast between formants and non-formants, thus increasing the saliency of the temporal and spectral cues for those formants which can increase the intelligibility significantly for individuals relying on such cues.

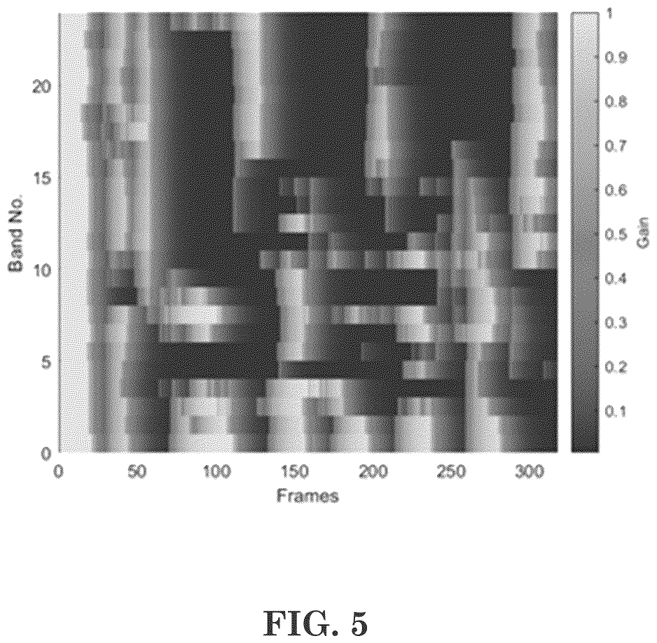

FIG. 5 is an illustration of intensity filter gains resulting from implementation of a sparsity compression scheme in accordance with any of the embodiments disclosed herein. As mentioned above, the intensity filtering is performed per frequency band. FIG. 5 shows the resulting gain for each frequency band (y-axis) as a function of frame (i.e., time). As shown, there are 24 frequency bands.

The intensity filter gains (sparsity gains) can be represented in gray scale or color coded. If represented in gray scale, the lightest portions correspond to unity gain (1) through the darkest portions corresponding to the lowest gain (0.01). If color coded in yellow through deep blue, for example, the yellow corresponds to unity gain through deep blue corresponding to the lowest gain. As such, the lightest portions (e.g., intense yellow parts) correspond to the portions of the input signal (speech) that are passed through while the darkest portions (e.g., deep blue parts) correspond to the portions of the input signal that are strongly attenuated. In some sense, the illustration of intensity filter gains shown in FIG. 5 resembles a spectrogram of the speech showing only the most intense parts of the speech.

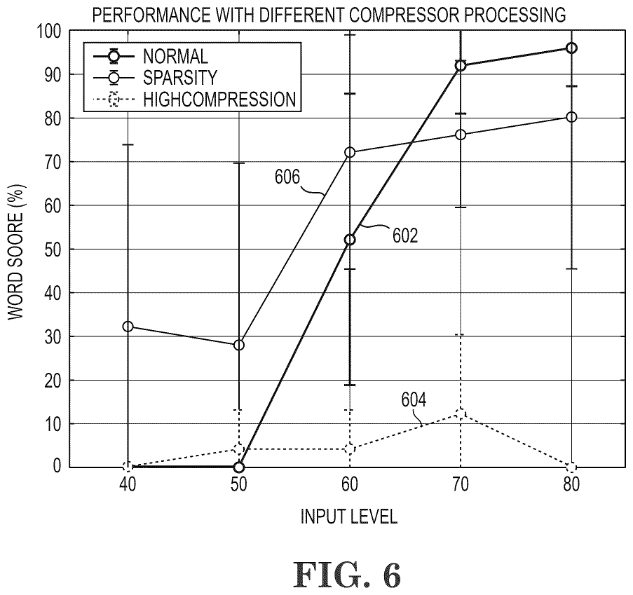

FIG. 6 are plots of different compressor processing schemes illustrating the performance of a representative sparsity compression scheme relative to other compression schemes. FIG. 6 shows an example of the results of a test performed on a group of hearing-impaired participants. Curve 602 (“Normal”) shows the performance in terms of word score percentage as a function of input signal levels when using a normal compression scheme. Curve 602 shows a score of 0 for low input levels increasing to close to 100% at higher input levels. Curve 604 (“High Compression”) shows the word score when using a fast and high degree of compression alone. As can be seen, curve 604 never surpasses much higher than 10%. Curve 606 (“Sparsity”) shows the word score when a sparsity compression scheme is applied to the input signal. It is noted that the normal compression scheme comprises a slower and lower degree of compression relative to that of the sparsity compression scheme. It can be seen that, at low input levels, the word score for curve 606 is increased by as much as 20-30%.

In some cases, there can be a crossover at higher input levels (above 65 dB SPL) where the normal compression scheme (curve 602) results in a word score that is higher than for the sparsity compression scheme (curve 606). In such cases, the sparsity compression scheme and the normal compression scheme can be implemented together in a coordinated manner. For example, the sparsity compression scheme can be implemented below a certain input level (e.g., below 65 dB SPL) and the normal compression scheme can be implemented at higher input levels (e.g., above 65 dB SPL). It is expected that the sparsity compression scheme can be further developed to eliminate a crossover effect.

If a crossover approach is implemented where the sparsity compression scheme is employed below a certain input level and the normal compression scheme is employed above this input level, a transition region can be defined where the compression time constants (attack and release time constants) used in the sparsity compression scheme are gradually changed to that of the normal compression scheme as the input level increases, and vice versa. At the same time, the suppressive gain used in the sparsity gain can gradually transition from its most suppressive gain to a gain of 1 where all of the input signal is passed through as input levels increase across the transition region, and vice versa. Lastly, the compression gains used for the sparsity compression scheme can transition to those applied for the normal compression scheme during the transition as input levels increase, and vice versa.

It is noted that the sparsity compression scheme may be applied on a per frequency band basis such that, for example, it is applied only at higher frequencies where the hearing loss may be more severe or profound and a normal compression scheme is applied to the lower frequencies.

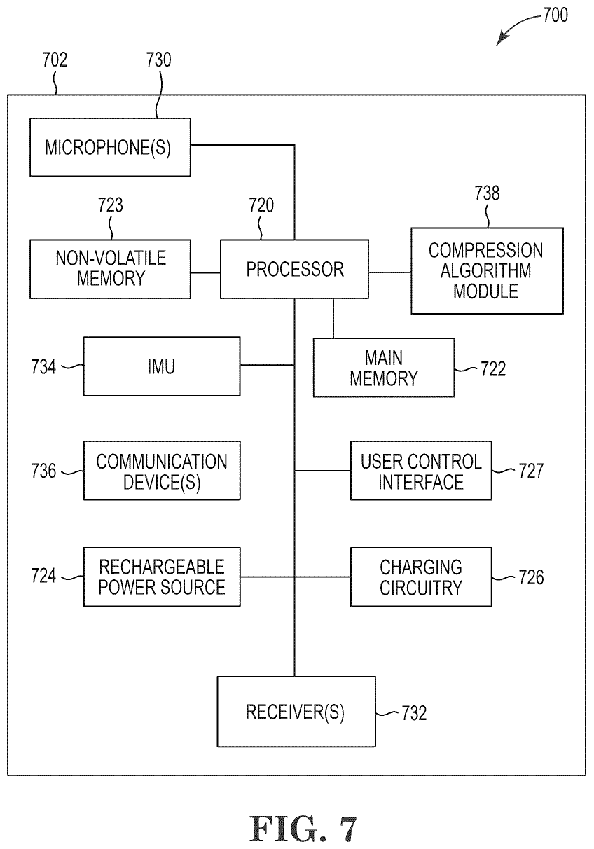

In FIG. 7, a block diagram illustrates a system and ear-worn hearing device 700 in accordance with any of the embodiments disclosed herein. The hearing device 700 includes a housing 702 configured to be worn in, on, or about an ear of a wearer. The hearing device 700 shown in FIG. 7 can represent a single hearing device configured for monaural or single-ear operation or one of a pair of hearing devices configured for binaural or dual-ear operation. The hearing device 700 shown in FIG. 7 includes a housing 702 within or on which various components are situated or supported. The housing 702 can be configured for deployment on a wearer's ear (e.g., a behind-the-ear device housing), within an ear canal of the wearer's ear (e.g., an in-the-ear, in-the-canal, invisible-in-canal, or completely-in-the-canal device housing) or both on and in a wearer's ear (e.g., a receiver-in-canal or receiver-in-the-ear device housing).

The hearing device 700 includes a processor 720 operatively coupled to a main memory 722 and a non-volatile memory 723. The processor 720 can be implemented as one or more of a multi-core processor, a digital signal processor (DSP), a microprocessor, a programmable controller, a general-purpose computer, a special-purpose computer, a hardware controller, a software controller, a combined hardware and software device, such as a programmable logic controller, and a programmable logic device (e.g., FPGA, ASIC). The processor 720 can include or be operatively coupled to main memory 722, such as RAM (e.g., DRAM, SRAM). The processor 720 can include or be operatively coupled to non-volatile (persistent) memory 723, such as ROM, EPROM, EEPROM or flash memory. The non-volatile memory 723 is configured to store instructions (e.g., module 738) that are executable by the processor 720 for implementing a sparsity compression scheme as previously described.

The hearing device 700 includes an audio processing facility (also referred to as an audio processor circuit) operably coupled to, or incorporating, the processor 720. The audio processing facility includes audio signal processing circuitry (e.g., analog front-end, analog-to-digital converter, digital-to-analog converter, DSP, and various analog and digital filters), a microphone arrangement 730, and one or more receivers 732. The one or more receivers 732 produce amplified sound inside of the ear canal. The microphone arrangement 730 can include one or more discrete microphones or a microphone array(s) (e.g., configured for microphone array beamforming). Each of the microphones of the microphone arrangement 730 can be situated at different locations of the housing 702 and can include an inward-facing microphone. The hearing device 700 can include one or more sensors, such as an inertial measurement unit 734.

The hearing device 700 may also include a user interface with a user control interface 727 operatively coupled to the processor 720. The user control interface 727 is configured to receive an input from the wearer of the hearing device 700. The input from the wearer can be any type of user input, such as a touch input, a gesture input, or a voice input.

The hearing device 700 also includes a compression algorithm module 738 operably coupled or integral to the processor 720. The module 738 can be implemented in software, hardware, or a combination of hardware and software. The processor 720 cooperates with the module 738 to implement a sparsity compression scheme in a manner discussed above.

The hearing device 700 can include one or more communication devices 736. For example, the one or more communication devices 736 can include one or more radios coupled to one or more antenna arrangements that conform to an IEEE 702.7 (e.g., Wi-Fi®) or Bluetooth® (e.g., BLE, Bluetooth® 4.2, 5.0-5.4 or later) specification, for example. In addition, or alternatively, the hearing device 700 can include a near-field magnetic induction (NFMI) sensor (e.g., an NFMI transceiver coupled to a magnetic antenna) for effecting short-range communications (e.g., ear-to-ear communications, ear-to-kiosk communications). The communications device 736 may also include wired communications, e.g., universal serial bus (USB) and the like. The communication device 736 is operable to allow the hearing device 700 to communicate with an external computing device, e.g., a mobile device such as smartphone, laptop computer, tablet, etc.

The hearing device 700 also includes a power source, which can be a conventional battery, a rechargeable battery (e.g., a lithium-ion battery), or a power source comprising a supercapacitor. In the embodiment shown in FIG. 7, the hearing device 700 includes a rechargeable power source 724 which is operably coupled to power management circuitry for supplying power to various components of the hearing device 700. The rechargeable power source 724 is coupled to charging circuity 726. The charging circuitry 726 is electrically coupled to charging contacts on the housing 702 which are configured to electrically couple to corresponding charging contacts of a charger when the hearing device 700 is placed in the charger. The charger may be a charging case with a lid that can be closed after placing the hearing device(s) 700 inside the case.

Representative embodiments of the disclosure are defined in the following Examples. Below there is provided a non-exhaustive listing of non-limiting examples. Any one or more of the features of these examples may be combined with any one or more features of another example, embodiment, or aspect described herein.

Example Ex1. A method implemented by a hearing device comprises receiving an input signal comprising speech, applying a fast and high degree of compression to the input signal to provide a compressed signal, filtering the input signal by which intense portions of the input signal above a threshold are assigned a high gain value and less intense portions of the input signal below the threshold are assigned a low gain value, the high and low gain values defining sparsity gains, and applying the sparsity gains to the compressed signal to produce an output signal.

Example Ex2. The method according to Ex1, wherein the fast compression comprises attack and release time constants of 100 ms or less.

Example Ex3. The method according to Ex1, wherein the high degree of compression comprises a compression ratio of 7:1 or higher.

Example Ex4. The method according to Ex1, wherein the high gain value is a gain of one, and the low gain value is a suppressive gain value.

Example Ex5. The method according to Ex1, wherein the intense portions of the input signal generally correspond to formants of the input signal and the less intense portions of the input signal generally correspond to non-formants of the input signal.

Example Ex6. The method according to Ex1, wherein filtering of the input signal comprises tracking peaks of the input signal and defining a maximum tracking value between peaks, assigning the high gain value to portions of the input signal within a specified threshold of the maximum tracking value, assigning the low gain value to portions of the input signal below the specified threshold of the maximum tracking value.

Example Ex7. The method according to Ex1, wherein the compression and filtering are performed on a per frequency band basis, and the threshold differs based on the frequency band.

Example Ex8. The method according to Ex1, wherein, the method defines a sparsity compression scheme which is implemented for input signals below a specified input level, and the method further comprises applying a normal compression scheme to input signals above the specified input level, wherein the normal compression scheme comprises a slower and lower degree of compression relative to that of the sparsity compression scheme.

Example Ex9. The method according to Ex8, comprising gradually changing attack and release time constants of compression when transitioning between the sparsity and normal compression schemes.

Example Ex10. The method according to Ex8, comprising gradually changing suppressive gains used in the sparsity compression scheme when transitioning between the sparsity and normal compression schemes.

Example Ex11. The method according to Ex8, comprising gradually changing compression gains used in the sparsity compression scheme when transitioning between the sparsity and normal compression schemes.

Example Ex12. The method according to Ex1, wherein the method defines a sparsity compression scheme which is implemented on a per frequency band basis for input signals having a frequency above a threshold frequency, and the method further comprises applying a normal compression scheme to input signals having a frequency below the threshold frequency, wherein the normal compression scheme comprises a slower and lower degree of compression relative to that of the sparsity compression scheme.

Example Ex13. The method according to Ex1, wherein the hearing device is configured to be worn in or on an ear of a wearer.

Example Ex14. A hearing device comprises at least one microphone, a receiver or speaker, and a controller comprising one or more processors configured to implement a sparsity compression scheme. The controller, when implementing the sparsity compression scheme, is configured to apply a fast and high degree of compression to an input signal received by the microphone to provide a compressed signal, filter the input signal by which intense portions of the input signal above a threshold are assigned a high gain value and less intense portions of the input signal below the threshold are assigned a low gain value, the high and low gain values defining sparsity gains, and apply the sparsity gains to the compressed signal to produce an output signal communicated to the receiver or speaker.

Example Ex15. The device according to Ex14, wherein the fast compression comprises attack and release time constants of 100 ms or less.

Example Ex16. The device according to Ex14, wherein the high degree of compression comprises a compression ratio of 7:1 or higher.

Example Ex17. The device according to Ex14, wherein the high gain value is a gain of one, and the low gain value is a suppressive gain value.

Example Ex18. The device according to Ex14, wherein the intense portions of the input signal generally correspond to formants of the input signal and the less intense portions of the input signal generally correspond to non-formants of the input signal.

Example Ex19. The device according to Ex14, wherein filtering of the input signal by the controller comprises tracking peaks of the input signal and defining a maximum tracking value between peaks, assigning the high gain value to portions of the input signal within a specified threshold of the maximum tracking value, and assigning the low gain value to portions of the input signal below the specified threshold of the maximum tracking value.

Example Ex20. The device according to Ex14, wherein the compression and filtering are performed by the controller on a per frequency band basis, and the threshold differs based on the frequency band.

Example Ex21. The device according to Ex14, wherein the controller is configured to implement the sparsity compression scheme for input signals below a specified input level, and to apply a normal compression scheme to input signals above the specified input level, wherein the normal compression scheme comprises a slower and lower degree of compression relative to that of the sparsity compression scheme.

Example Ex22. The device according to Ex21, wherein the controller is configured to gradually change attack and release time constants of compression when transitioning between the sparsity and normal compression schemes.

Example Ex23. The device according to Ex21, wherein the controller is configured to gradually change suppressive gains used in the sparsity compression scheme when transitioning between the sparsity and normal compression schemes.

Example Ex24. The device according to Ex21, wherein the controller is configured to gradually change compression gains used in the sparsity compression scheme when transitioning between the sparsity and normal compression schemes.

Example Ex25. The device according to Ex14, wherein the controller is configured to implement the sparsity compression scheme on a per frequency band basis for input signals having a frequency above a threshold frequency, and to implement a normal compression scheme to input signals having a frequency below the threshold frequency, wherein the normal compression scheme comprises a slower and lower degree of compression relative to that of the sparsity compression scheme.

Example Ex26. The device according to Ex14, wherein the hearing device is configured to be worn in or on an ear of a wearer.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The terms “connected” or “coupled” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality. Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. A method implemented by a hearing device, comprising:
receiving an input signal comprising speech;
applying a fast and high degree of compression to the input signal to provide a compressed signal;
filtering the input signal by which intense portions of the input signal above a threshold are assigned a high gain value and less intense portions of the input signal below the threshold are assigned a low gain value, the high and low gain values defining sparsity gains; and
applying the sparsity gains to the compressed signal to produce an output signal.

2. The method of claim 1, wherein the fast compression comprises attack and release time constants of 100 ms or less.

3. The method of claim 1, wherein the high degree of compression comprises a compression ratio of 7:1 or higher.

4. The method of claim 1, wherein filtering of the compressed signal comprises:
tracking peaks of the input signal and defining a maximum tracking value between peaks;
assigning the high gain value to portions of the input signal within a specified threshold of the maximum tracking value; and
assigning the low gain value to portions of the input signal below the specified threshold of the maximum tracking value.

5. The method of claim 1, wherein:
the method defines a sparsity compression scheme which is implemented for input signals below a specified input level; and
the method further comprises applying a normal compression scheme to input signals above the specified input level, wherein the normal compression scheme comprises a slower and lower degree of compression relative to that of the sparsity compression scheme.

6. The method of claim 5, comprising gradually changing attack and release time constants of compression when transitioning between the sparsity and normal compression schemes.

7. The method of claim 5, comprising gradually changing suppressive gains used in the sparsity compression scheme when transitioning between the sparsity and normal compression schemes.

8. The method of claim 5, comprising gradually changing compression gains used in the sparsity compression scheme when transitioning between the sparsity and normal compression schemes.

9. The method of claim 1, wherein:
the method defines a sparsity compression scheme which is implemented on a per frequency band basis for input signals having a frequency above a threshold frequency, and
the method further comprises applying a normal compression scheme to input signals having a frequency below the threshold frequency, wherein the normal compression scheme comprises a slower and lower degree of compression relative to that of the sparsity compression scheme.

10. A hearing device, comprising:
at least one microphone;
a receiver or speaker; and
a controller comprising one or more processors configured to implement a sparsity compression scheme, the controller, when implementing the sparsity compression scheme, configured to:
apply a fast and high degree of compression to an input signal received by the microphone to provide a compressed signal;
filter the input signal by which intense portions of the input signal above a threshold are assigned a high gain value and less intense portions of the input signal below the threshold are assigned a low gain value, the high and low gain values defining sparsity gains; and
apply the sparsity gains to the compressed signal to produce an output signal communicated to the receiver or speaker.

11. The device of claim 10, wherein the fast compression comprises attack and release time constants of 100 ms or less.

12. The device of claim 10, wherein the high degree of compression comprises a compression ratio of 7:1 or higher.

13. The device of claim 10, wherein the high gain value is a gain of one, and the low gain value is a suppressive gain value.

14. The device of claim 10, wherein the intense portions of the input signal generally correspond to formants of the input signal and the less intense portions of the input signal generally correspond to non-formants of the input signal.

15. The device of claim 10, wherein filtering of the compressed signal by the controller comprises:
tracking peaks of the input signal and defining a maximum tracking value between peaks;
assigning the high gain value to portions of the input signal within a specified threshold of the maximum tracking value; and
assigning the low gain value to portions of the input signal below the specified threshold of the maximum tracking value.

16. The device of claim 10, wherein:
the controller is configured to implement the sparsity compression scheme for input signals below a specified input level; and
the controller is configured to apply a normal compression scheme to input signals above the specified input level, wherein the normal compression scheme comprises a slower and lower degree of compression relative to that of the sparsity compression scheme.

17. The device of claim 16, wherein the controller is configured to gradually change attack and release time constants of compression when transitioning between the sparsity and normal compression schemes.

18. The device of claim 16, wherein the controller is configured to gradually change suppressive gains used in the sparsity compression scheme when transitioning between the sparsity and normal compression schemes.

19. The device of claim 16, wherein the controller is configured to gradually change compression gains used in the sparsity compression scheme when transitioning between the sparsity and normal compression schemes.

20. The device of claim 10, wherein:
the controller is configured to implement the sparsity compression scheme on a per frequency band basis for input signals having a frequency above a threshold frequency, and
the controller is configured to implement a normal compression scheme to input signals having a frequency below the threshold frequency, wherein the normal compression scheme comprises a slower and lower degree of compression relative to that of the sparsity compression scheme.
